(19) United States
(12) Patent Application Publication
(10) Pub. No.: US 2008/0309576 A1
(43) Pub. Date: Dec. 18, 2008

(54) Single band antenna

(75) Inventor: Wen-Szu Tao, Hsinchu City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/808,671

(22) Filed: Jun. 12, 2007

(51) Int. Cl. H01Q 9/06

(52) U.S. Cl. 343/845; 343/893

(57) ABSTRACT

A single band antenna includes a radiating unit, a grounding unit, a feeding unit and a conductive unit. The radiating unit has a bent portion. The grounding unit and the feeding unit protrude from one end of the radiating unit with an interval therebetween. The conductive unit has a conductive body and a grounding body. The conductive body is electrically connected with the feeding unit, and the grounding body is electrically connected with the grounding unit.

### BACKGROUND OF THE INVENTION

1. Field of Invention

The invention relates to an antenna and, in particular, to a single band antenna.

2. Related Art

The rapid developments in radio transmission have brought various products and technologies to market, particularly in the field of multi-band transmission, in order for products to meet the consumer's ever developing requirements. The antenna is an important element for transmitting and receiving electromagnetic wave energy in radio transmission systems. Without an antenna, the radio transmission system cannot transmit and receive data. Thus, the antenna plays an indispensable role in the radio transmission system.

An appropriate antenna is selected to accommodate product features and enhance the transmission while minimizing product cost. Different methods and different materials for manufacturing the antennas are used in different products. In addition, antennas are designed in consideration of different frequency bands used in different countries.

As shown in FIG. 1, a conventional single band antenna 1 includes a radiating unit 11, a feeding unit 12 and a grounding unit 13. The radiating unit 11 is a plate with a stripe shape. The feeding unit 12 protrudes from a point of the radiating unit 11 and the grounding unit 13 protrudes from an end of the radiating unit 11. Herein, the grounding unit 13 and the feeding unit 12 protrude in the same direction.

The single band antenna 1 can operate on a frequency band via the radiating unit 11. The frequency band, for example, is compliant with 2.4 GHz, as specified by IEEE 802.11b/g, or 5 GHz, as specified by IEEE 802.11a.

However, in order to optimize the inductance-capacitance effect of the single band antenna 1, the distance between the feeding unit 12 and the grounding unit 13 must be longer than a certain length, e.g. 3 mm. Unfortunately, this feature also restricts the design and arrangement of the single band antenna 1. Furthermore, since the radiating unit 11 of the single band antenna 1 has a stripe shape, it can not accommodate the demand for miniaturization when the single band antenna 1 is too long, especially when it operates in a low frequency (LF) band.

### SUMMARY OF THE INVENTION

In view of the foregoing, the invention is to provide a miniature single band antenna to reduce the design limitations and further to increase its adaptability and efficiency.

To achieve the above, a single band antenna of the invention includes a radiating unit, a grounding unit, a feeding unit and a conductive unit. The radiating unit has a bent portion. The grounding unit and the feeding unit protrude from one end of the radiating unit. There is an interval between the grounding unit and the feeding unit. The conductive unit has a conductive body and a grounding body. The conductive body is electrically connected with the feeding unit, and the grounding body is electrically connected with the grounding unit.

As mentioned above, the radiating unit of the single band antenna of the invention has a bent portion. Compared with the prior art, the radiating unit can achieve the same resonance length with a shorter profile, so that the single band antenna can be more easily miniaturized. In addition, it is testified and verified that the inductance-capacitance effect of the single band antenna of the invention can be greatly enhanced through the bent portion of the radiating unit. That is, the distance between the feeding unit and the grounding unit in the invention can be less than that in the prior art. It hence reduces the design limitations and increases the adaptability and efficiency of the antenna. In addition, the grounding unit and feeding unit of the single band antenna of the invention can be connected to the circuit board by surface mounting technology (SMT), hence simplifying the manufacturing process and enhancing the structure strength.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional single band antenna;

FIG. 2 is a schematic view of the single band antenna according to a preferred embodiment of the invention;

FIG. 3 is a schematic view of the single band antenna with a substrate according to the preferred embodiment of the invention;

FIG. 4 is a schematic view showing the single band antenna according to the preferred embodiment of the invention, wherein the grounding unit and the feeding unit are disposed on the substrate;

FIG. 5 shows two single antennas according to the preferred embodiment of the invention;

FIG. 6 shows VSWR of the left antenna according to the preferred embodiment of the invention;

FIG. 7 shows VSWR of the right antenna according to the preferred embodiment of the invention;

FIGS. 8 to 10 show the radiation fields of the left antenna when it operates at 2.4 GHz, 2.45 GHz and 2.5 GHz, respectively; and

FIGS. 11 to 13 show the radiation fields of the right antenna when it operates at 2.4 GHz, 2.45 GHz and 2.5 GHz, respectively.

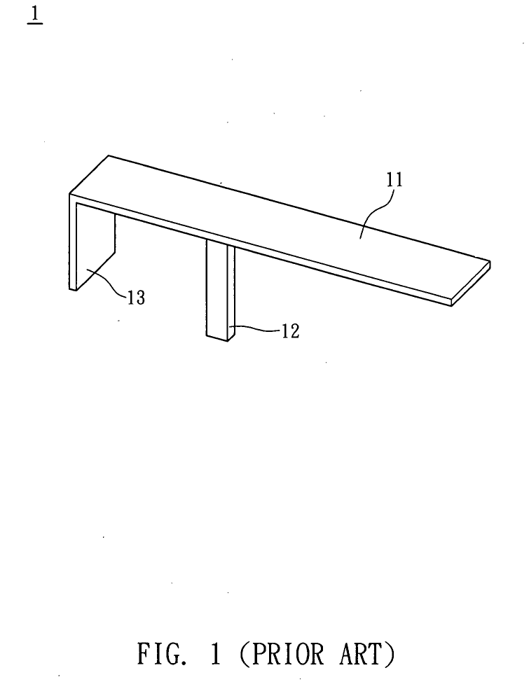

### DETAILED DESCRIPTION OF THE INVENTION

The present invention will be apparent from the following detailed description, which proceeds with reference to the accompanying drawings, wherein the same references relate to the same elements.

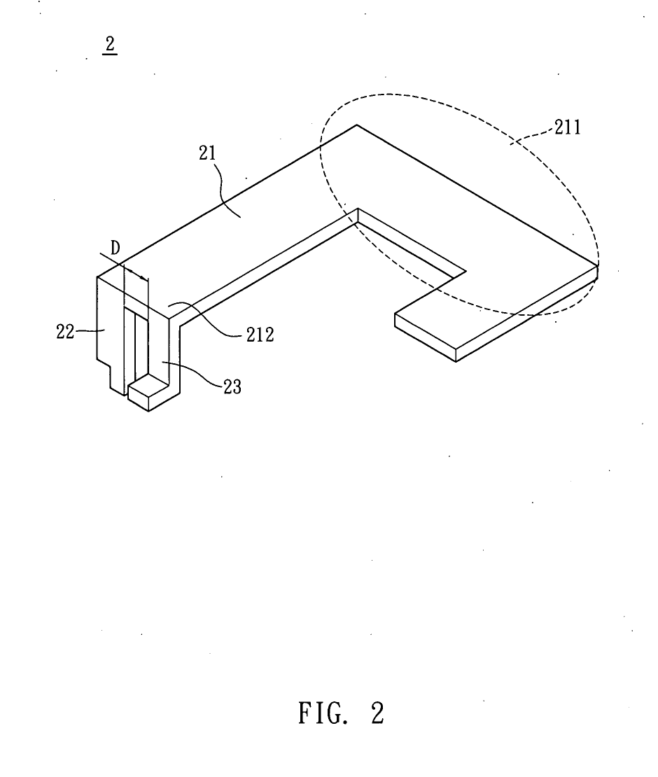

As shown in FIG. 2, a single band antenna 2 according to a preferred embodiment of the invention includes a radiating unit 21, a grounding unit 22 and a feeding unit 23. The radiating unit 21 has a bent portion 211. In the embodiment, the radiating unit 21 is a metal plate, and the bent portion 211 may have a right angle or may be hook-shaped or arc-shaped. The grounding unit 22 and the feeding unit 23 protrude from one end 212 of the radiating unit 21, and an interval, distance D, is provided between the grounding unit 22 and the feeding unit 23. In the embodiment, the distance D is smaller than 3 mm.

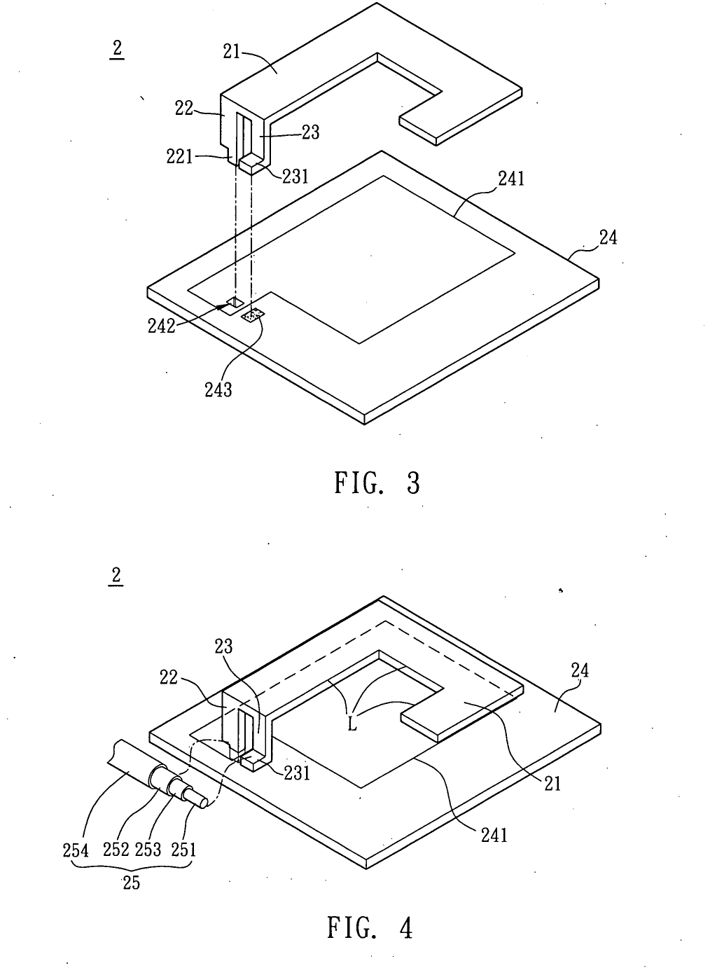

As shown in FIG. 3, the single band antenna 2 further includes a substrate 24. The radiating unit 21 is disposed on the substrate 24 by the grounding unit 22 and the feeding unit 23. Herein, the substrate 24 is a printed circuit board (PCB). The substrate 24 has a grounding area 241, which is disposed opposite to the radiating unit 21. The grounding unit 22 is electrically connected with the grounding area 241.

In the embodiment, there are many available methods to dispose the grounding unit 22 and the feeding unit 23 on the substrate 24. For example, the grounding unit 22 has a pin 221, which can be inserted into the substrate 24. Of course, the substrate 24 has a hole 242 provided corresponding to the pin 221. Alternatively, the feeding unit 23 may have a connecting pad 231 which is welded to a connecting pad 243 of the substrate 24. Herein, the connecting pad 231 is mounted on the connecting pad 243 of the substrate 24 by surface mounting technology (SMT). Of course, the grounding unit could be welded to the substrate 24 with connecting pads, or the feeding unit 23 could have a pin inserted into the substrate 24.

Furthermore, the single band antenna 2 of the embodiment could be installed in an electronic apparatus, such as a portable electronic apparatus. The portable electronic apparatus is, for example, a notebook, a mobile communication apparatus or a personal digital assistant (PDA). Of course, the single band antenna 2 could also be configured in other electronic devices demanding antennas, such as a network interface card (NIC) with a personal computer memory card international association (PCMCIA) interface or a compact flash (CF) interface card. Of course, for some specific conditions, such as multiplexing with three antennas for the standard of IEEE 802.11n, the single band antenna 2 could cooperate with other kinds of antennas or other single band antennas 2.

As shown in FIG. 4, the grounding unit 22 and the feeding unit 23 are disposed on the substrate 24. In this case, the single band antenna 2 further includes a conductive unit 25, which may be, but is not limited to, a coaxial cable. As shown in FIG. 4, the conductive unit 25 has a conductive body 251 and a grounding body 252. The conductive body 251 is electrically connected with the feeding unit 23, and the grounding body 252 is electrically connected with the grounding unit 22. Herein, the grounding body 252 may be electrically connected with the grounding unit 22 directly or indirectly. For example, the grounding body 252 could be directly coupled to the grounding area 241, and thus electrically connected with the grounding unit 22 indirectly. Furthermore, the conductive unit 25 includes a first insulating layer 253 and a second insulating layer 254. The first insulating layer 253 is disposed between the conductive body 251 and the grounding body 252, and the second insulating layer 254 is a surface layer of the conducive unit 25 for providing insulation and protecting the inside elements.

As mentioned above, the single band antenna 2 operates in a frequency band through the radiating unit 21. In the embodiment, the frequency band could be compliant with IEEE 802.11a, IEEE 802.11b/g or IEEE 802.11n, which has an operating bandwidth from 2.4 GHz to 2.5 GHz or from 5 GHz to 5.8 GHz. In the embodiment, the length of an inner boundary L of the radiating unit 21 is roughly a quarter wavelength of the frequency band. Of course, the inner boundary L could be changed slightly according to the location and orientation of the single band antenna 2 so as to optimize performance.

Please note that it is common knowledge in this field of technology that the operating frequency band of the antenna is related to its dimensions, and the dimensions can be changed according to the operating frequency band of the antenna. For example, the dimension of the antenna could be changed by the rule as follows. The resonance length of the antenna is a quarter or a half wavelength of the operating frequency band. In other words, when the dimensions of the antenna are changed, the operating frequency band of the antenna is correspondingly changed.

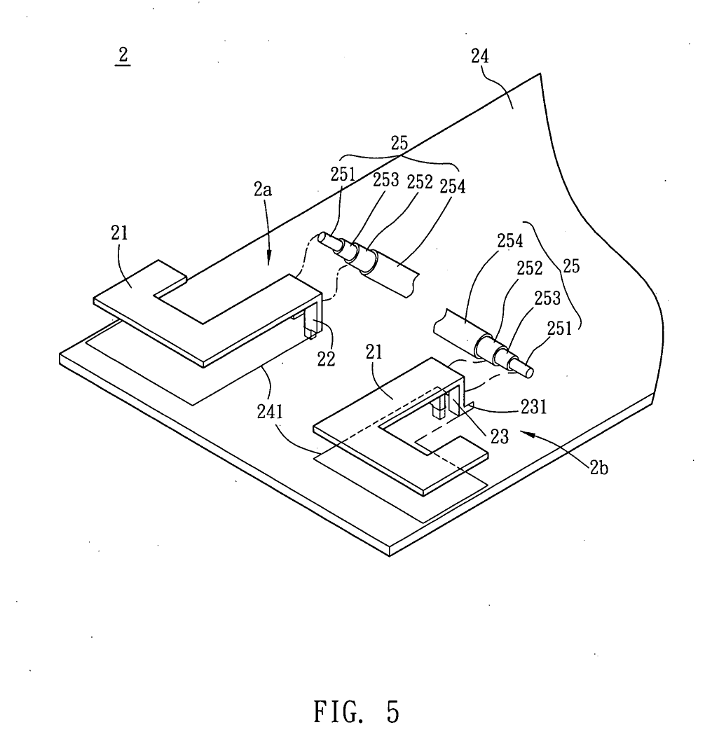

In addition, in, order to obtain a better effect in the spatial diversity and the radiation pattern diversity, a plurality of single band antennas 2 can cooperate with each other. As shown in FIG. 5, the radiating units 21, grounding units 22 and feeding units 23 of two single band antennas 2 are respectively disposed at two corners of the substrate 24. To make the invention more comprehensive, one of the single band antennas 2 is named as a left antenna 2a, and the other single band antenna 2 is named as a right antenna 2b.

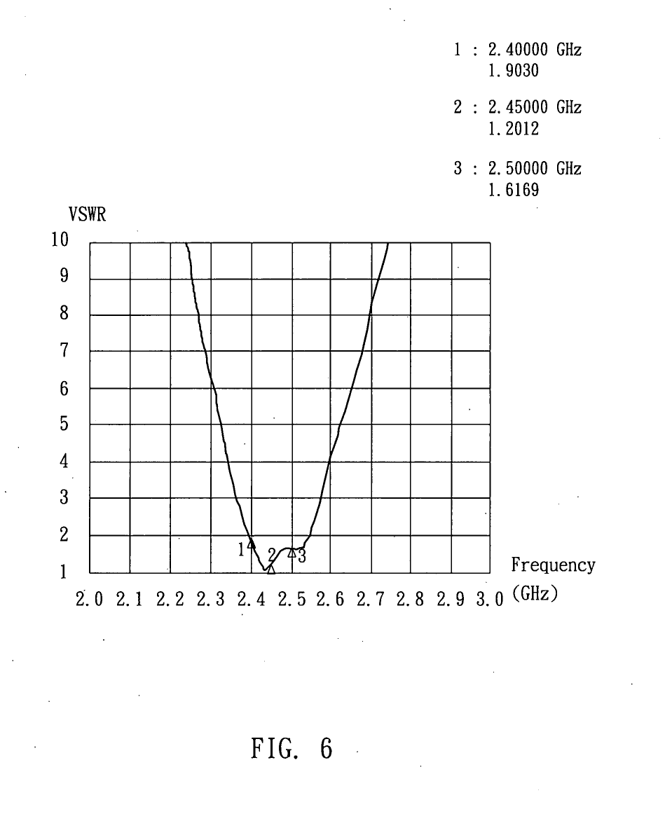

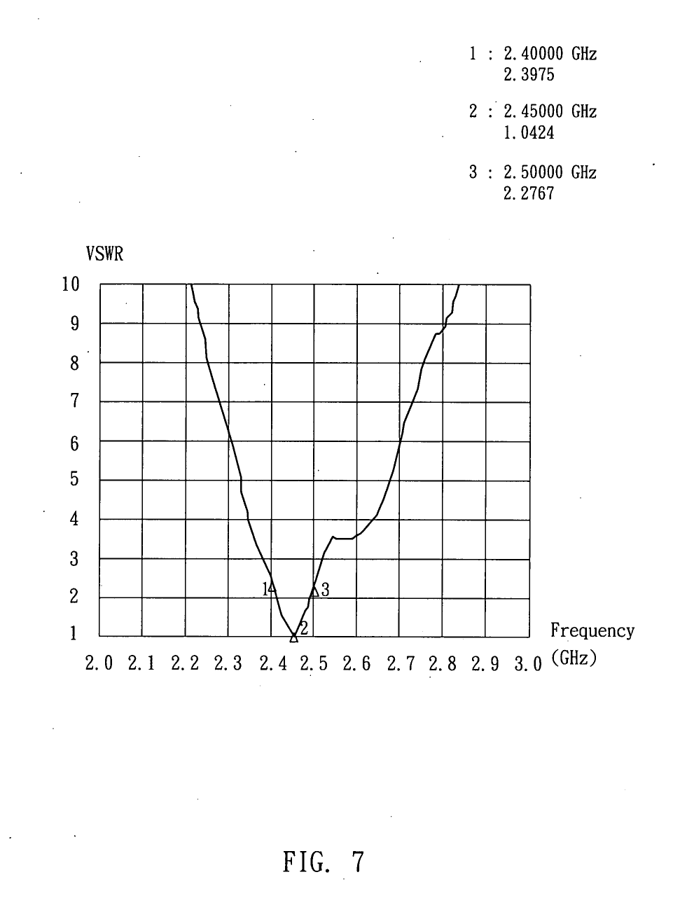

As shown in FIG. 6 and FIG. 7, the vertical axis is the voltage-standing wave ratio (VSWR) and the horizontal axis represents the frequency. It is acceptable generally for usual applications that the VSWR is less than 2.5, and it is observed in FIG. 6 and FIG. 7 that the disclosed left antenna 2a and right antenna 2b can operate between 2.4 GHz and 2.5 GHz.

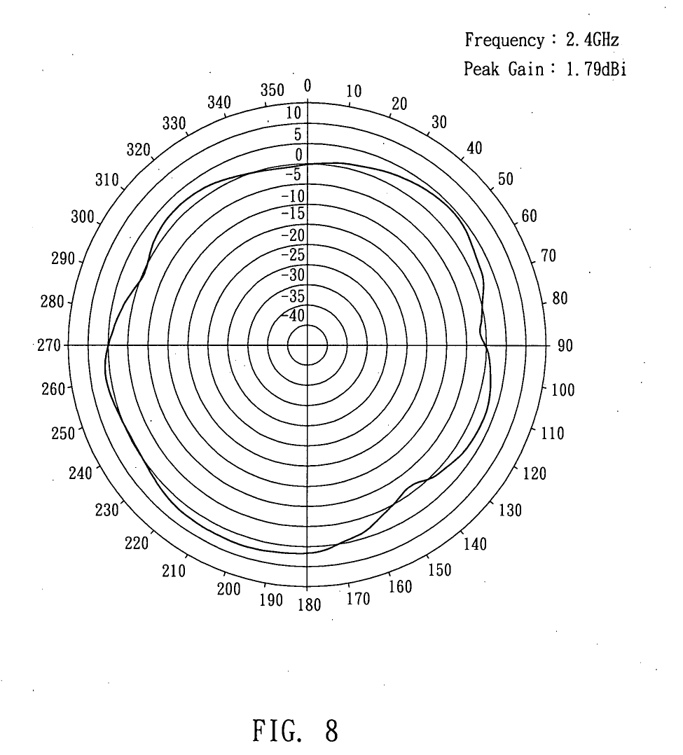

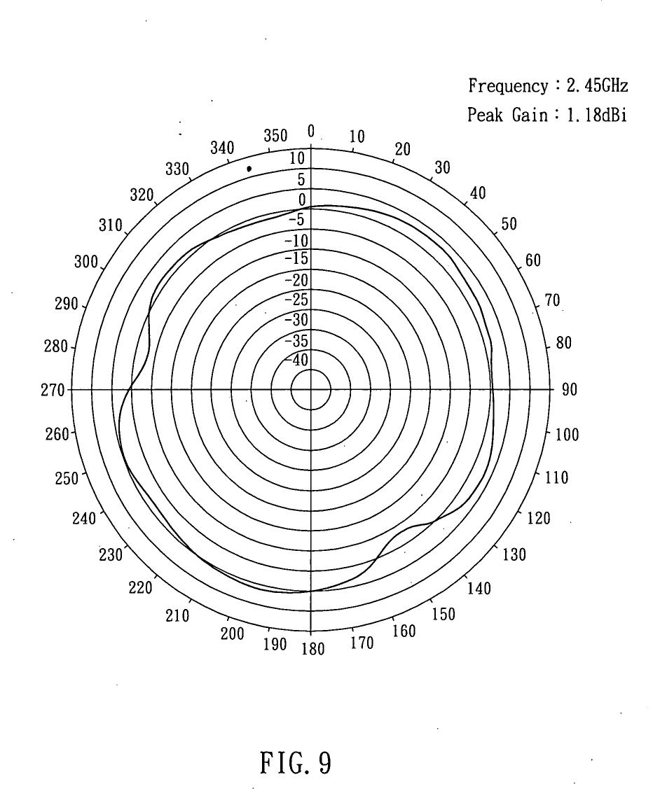

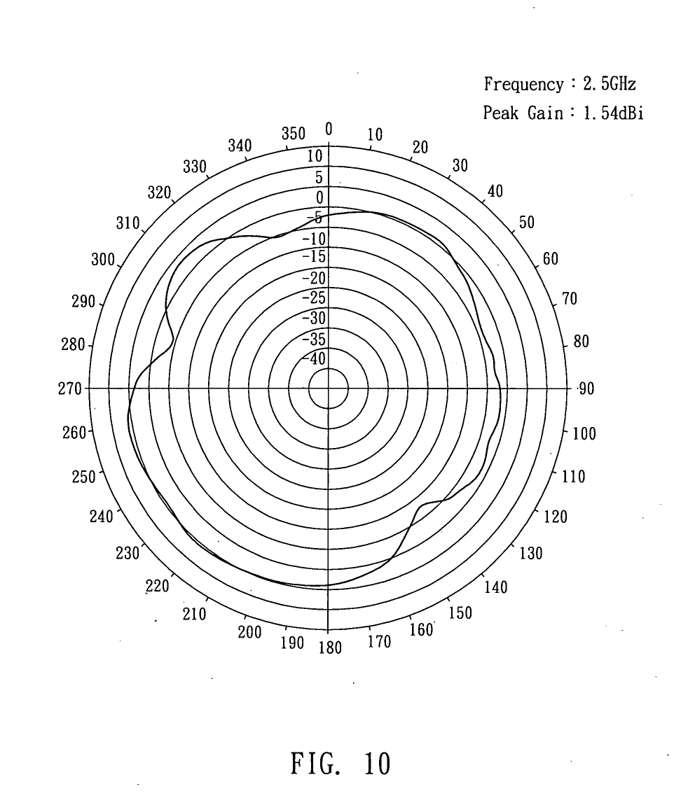

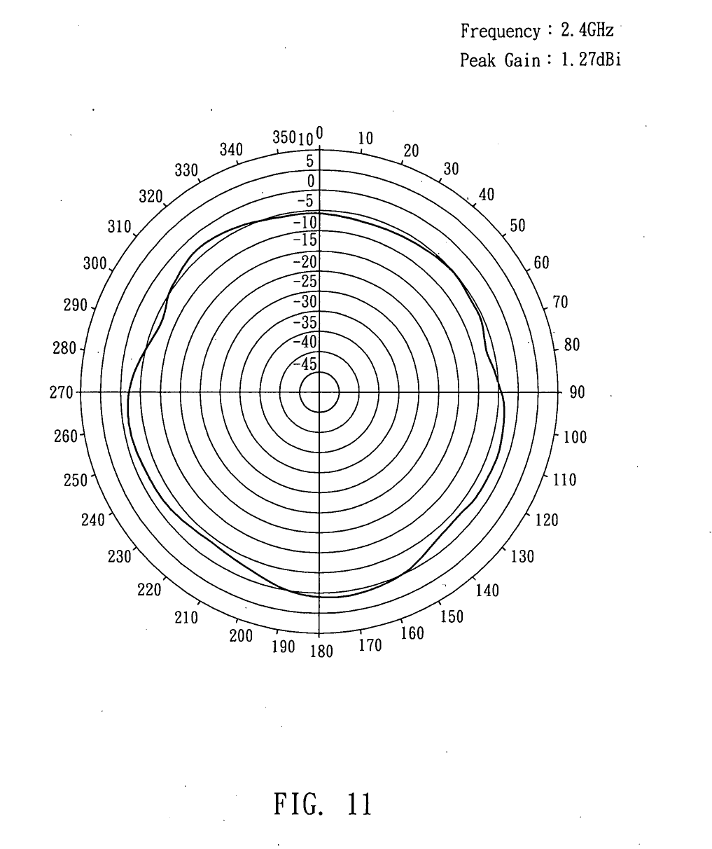

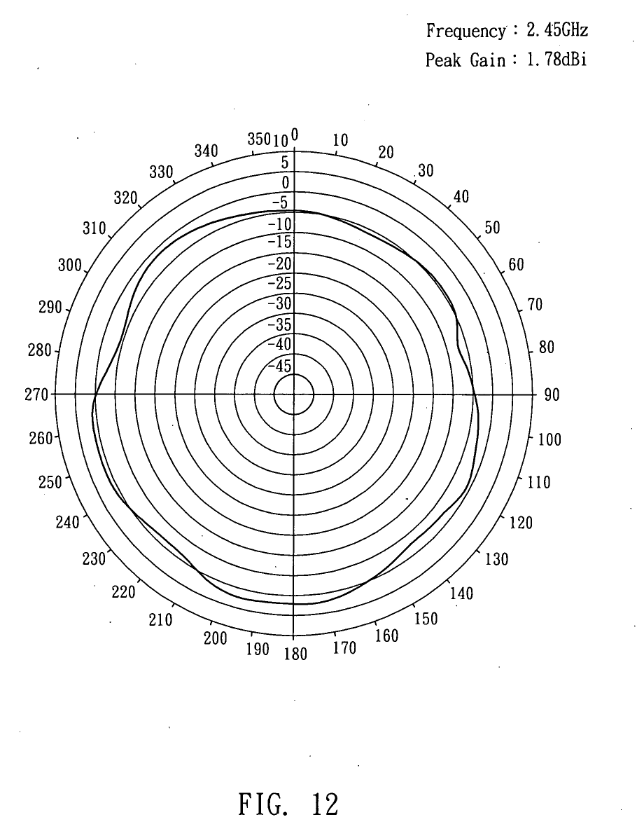

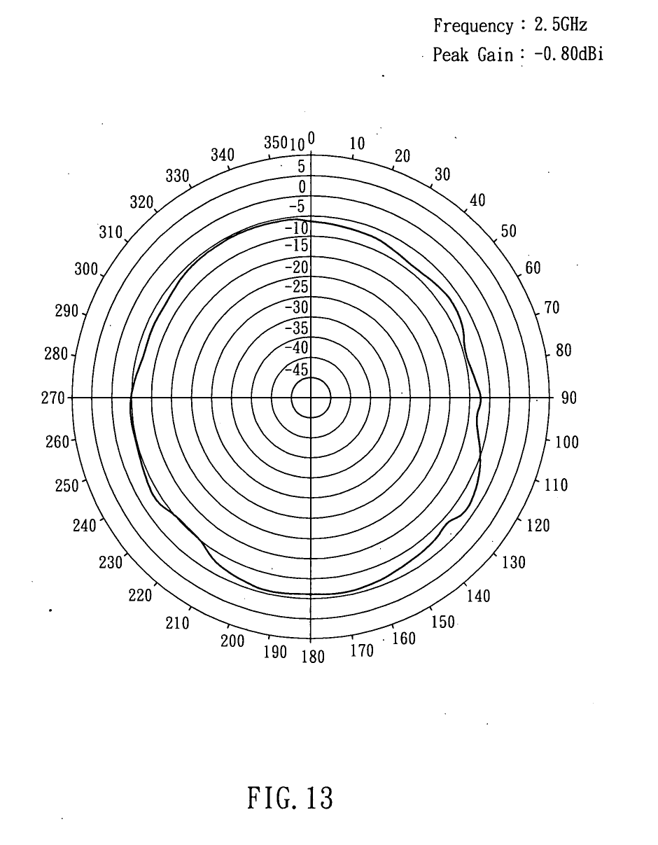

FIGS. 8 to 10 show the radiation fields of the disclosed left antenna 2a when it operates in the foregoing frequency band. Herein, FIGS. 8 to 10 show the radiation fields of the left antenna 2a when it operates at 2.4 GHz, 2.45 GHz and 2.5 GHz, respectively. FIGS. 11 to 13 show the radiation fields of the right antenna 2b when it operates in the above mentioned frequency band. Herein, FIGS. 11 to 13 show the radiation fields of the right antenna 2b when it operates at 2.4 GHz, 2.45 GHz and 2.5 GHz, respectively. Furthermore, it is testified and verified that the inductance-capacitance effect could be enhanced greatly by the bent portion 211 of the radiating unit 21, such that the distance D (as shown in FIG. 2) between the grounding unit 22 and the feeding unit 23 in the invention can be less than that in the prior art.

In summary, the radiating unit of the single band antenna of the invention has a bent portion. Compared with the prior art, the radiating unit achieves the same resonance length with a shorter profile, such that the single band antenna can be easily miniaturized. In addition, it is testified and verified that the inductance-capacitance effect of the single band antenna of the invention can be greatly enhanced by the bent portion of the radiating unit. That is, the distance between the feeding unit and the grounding unit in the invention can be less than that of the prior art. The invention disclosed herein hence reduces the design limitation and increases the adaptability and efficiency of the antenna. In addition, the grounding unit and feeding unit of the single band antenna of the invention can be connected to the circuit board by surface mounting technology (SMT), hence simplifying the manufacturing process and enhancing the structure strength.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A single band antenna, comprising:
a radiating unit, which has a bent portion;
a grounding unit protruding from one end of said radiating unit; and
a feeding unit protruding from the end of said radiating unit, wherein an interval is provided between said grounding unit and said feeding unit.

2. The single band antenna as recited in claim 1, wherein said interval is smaller than 3 mm.

3. The single band antenna as recited in claim 1, wherein said bent portion is hook-like.

4. The single band antenna as recited in claim 1, further comprising:
a conductive unit, which has a conductive body and a grounding body, wherein said conductive body is electrically connected with said feeding unit, and said grounding body is electrically connected with said grounding unit.

5. The single band antenna as recited in claim 1, further comprising a substrate, wherein said grounding unit and said feeding unit are disposed on said substrate.

6. The single band antenna as recited in claim 5, wherein said substrate has a grounding area, said radiating unit is disposed opposite to said grounding area, and said grounding unit is electrically connected with said grounding area.

7. The single band antenna as recited in claim 5, wherein said grounding unit or said feeding unit has a pin sticking into said substrate.

8. The single band antenna as recited in claim 5, wherein said grounding unit or said feeding unit has a connecting pad mounted on said substrate by surface mounting technology (SMT).

9. The single band antenna as recited in claim 5, wherein said single band antenna can cooperate with each other that said radiating units, grounding units, and feeding units of which are respectively disposed at corners of said substrate.

10. The single band antenna as recited in claim 1, which is configured in a network interface card.

11. An antenna module, comprising:
a plurality of single band antennas, wherein each of said single band antennas comprises a radiating unit, a grounding unit and a feeding unit, said radiating unit has a bent portion, said grounding unit and said feeding unit are protruding from one end of said radiating unit, an interval is provided between said grounding unit and said feeding unit; and
a substrate, wherein said grounding units and said feeding units are respectively disposed at corners of said substrate.

12. The antenna module as recited in claim 11, wherein said interval is smaller than 3 mm.

13. The antenna module as recited in claim 11, wherein said bent portion is hook-like.

14. The antenna module as recited in claim 11, wherein said substrate is a printed circuit board (PCB).

15. The antenna module as recited in claim 11, further comprising:
at least a conductive unit, which has a conductive body and a grounding body, wherein said conductive body is electrically connected with said feeding unit, and said grounding body is electrically connected with said grounding unit.

16. The antenna module as recited in claim 15, wherein the conductive unit is a coaxial cable.

17. The antenna module as recited in claim 11, wherein said substrate has at least a grounding area, said radiating unit is disposed opposite to said grounding area, and said grounding unit is electrically connected with said grounding area.

18. The antenna module as recited in claim 11, wherein said grounding unit or said feeding unit has a pin sticking into said substrate.

19. The antenna module as recited in claim 11, wherein said grounding unit or said feeding unit has a connecting pad mounted on said substrate by surface mounting technology (SMT).

20. The antenna module as recited in claim 11, which is configured in a network interface card.
